(19) United States
(12) Patent Application Publication
(10) Pub. No.: US 2009/0148646 A1
(43) Pub. Date: Jun. 11, 2009

(54) PORTABLE TISSUE PRODUCTS

(76) Inventors: Beth Marie Bachmann, Hamilton, OH (US); Noel Mathey Geoffroy, Cincinnati, OH (US); Kathryn Christian Kien, Cincinnati, OH (US); Connie Marie Roetker, Fairfield, OH (US); Rachael Eden Walther, Union, KY (US); Heather Sabrina Cummings, Portland, OR (US); William Travis Lonigan, Beaverton, OR (US); Paul Francis O'Connor, Portland, OR (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/953,403

(22) Filed: Dec. 10, 2007

(51) Int. Cl. B32B 3/10; B32B 3/00; B32B 3/06

(52) U.S. Cl. 428/43; 428/190; 428/99

(57) ABSTRACT

A tissue product having a plurality of absorbent, fibrous structure sheets comprising at least a first sheet and a second sheet that is adjacent to the first sheet, the first sheet and the second sheet each comprising a first end and a second end opposite to the first end, wherein the first end of the first sheet is proximal to the first end of the second sheet, and the second end of the first sheet and the second end of the second sheet are arranged in a splayed orientation.

### FIELD OF THE INVENTION

The present invention relates to tissue products having fibrous structure sheets and dispensers therefore, adapted to be readily accessible for use by the consumers in their homes or otherwise.

### BACKGROUND OF THE INVENTION

Tissue products such as paper towels, toilet tissue and facial tissue, are commonly provided with a variety of aesthetic as well as functional features. For example, tissue products are provided with a variety of floral or other graphic designs on the tissue structure or the packaging. These products also provide absorbency, strength, and softness for a variety of cleaning tasks.

Consumers want easy, convenient, and quick access to these products for use in their home or work areas. Spills or other messes are not limited to only one area of a home, but occur throughout the home. For example, spills and messes often occur in bathrooms, bedrooms, family rooms, and kitchen areas. Consumers want to clean up messes quickly to avoid damage to their furniture or home. Therefore, it would be desirable to provide tissue products in a portable form and with dispensing formats so that tissue products are quickly available when they are needed for clean-up.

Consumers also desire that these products are aesthetically pleasing and match their home decor. Since quick access to these tissue products require that they be sitting out on countertops or in plain view in bathroom, bedroom, family room, or kitchen areas, many consumers consider that these products are also décor accessories. In addition some consumers prefer clutter free living areas in their homes or work areas. Tissue products that serve multiple functions of being aesthetically pleasing as well as being readily available to serve a variety of useful cleaning tasks, are desirable.

Therefore a need exists for providing consumers with a wider variety of attractive tissue products and dispensing formats that will be readily usable and available in the consumer's home or office areas.

### SUMMARY OF THE INVENTION

The present invention relates to, in an embodiment, a tissue product comprising: a plurality of absorbent, fibrous structure sheets comprising at least a first sheet and a second sheet that is adjacent to the first sheet, the first sheet and the second sheet each comprising a first end and a second end opposite to the first end, wherein the first end of the first sheet is proximal to the first end of the second sheet, and the second end of the first sheet and the second end of the second sheet are arranged in a splayed orientation.

The invention further comprises a tissue product comprising: a plurality of absorbent, fibrous structure sheets comprising at least a first sheet and a second sheet that is adjacent to the first sheet, the first sheet and the second sheet each comprising a first end and a second end opposite to the first end, wherein the first end of the first sheet is proximal to the first end of the second sheet, and an attachment element disposed on the first ends, wherein the first sheet and the second sheet comprise a first distance D1 between the first ends and a second distance, D2, between the second ends, and wherein D2 is at least about 20% greater than D1.

The invention further relates to a tissue product comprising a plurality of absorbent, fibrous structure sheets comprising at least a first sheet and a second sheet that is adjacent to the first sheet, the first sheet and the second sheet each comprising a first end and a second end opposite to the first end, wherein the first end of the first sheet is proximal to the first end of the second sheet, and a refill package for a dispenser that arranges the second end of the first sheet and the second end of the second sheet in a splayed orientation.

### BRIEF DESCRIPTION OF THE DRAWINGS

While the specification concludes with claims particularly pointing out and distinctly claiming the present invention, it is believed that the present invention will be better understood from the following description in conjunction with the accompanying drawings, in which like reference numerals identify like elements and wherein:

FIG. 1 is a perspective view of a fibrous structure sheet in a folded configuration comprising a half-fold.

FIG. 2 s a perspective view of a fibrous structure sheet in a folded configuration comprising a quarter-fold.

FIG. 3 is a perspective view of a plurality of fibrous structure sheets in a half fold configuration housed in a dispenser.

FIG. 4 is a plain view of a plurality of fibrous structure sheets in a half fold configuration according to an embodiment of the invention.

FIG. 5 is a plain view of a tissue product with four fibrous structure sheets in a half fold configuration according to an embodiment of the invention.

### DETAILED DESCRIPTION OF THE INVENTION

### Definitions

“Splayed orientation” as used herein means that the second end of the first sheet and the second end of the second sheet are spread outward at a greater distance relative to the distance between the first end of the first sheet and the first end of the second sheet.

“Sheet” as used herein means a usable unit of fibrous structure. In an embodiment a sheet may be removed from a plurality of sheets for use by the consumer. A sheet may be folded or unfolded. In one embodiment a plurality of sheets may be continuous or discontinuous. For example, a plurality of discontinuous sheets comprise individual sheets having 4 different edges. In this regard the tissue product herein may be a stack of individual sheets. For example, a plurality of continuous sheets may be formed by a continuous fibrous structure web wherein the web is folded into sheets and the folded sheets are in a stacked configuration.

“Sanitary tissue product” or “tissue product” as used herein means a wiping implement for post-urinary and/or post-bowel movement cleaning (toilet tissue or wipe products), for otorhinolaryngological discharges (facial tissue products) and/or multi-functional absorbent and cleaning uses (absorbent towels such as paper towel products, table napkins and/or wipe products). The sanitary tissue products of the present invention may comprise one or more fibrous structures and/or finished fibrous structures, traditionally, but not necessarily, comprising cellulose fibers. In one embodiment, the tissue products of the present invention include tissue-towel paper products.

A “tissue-towel paper product” refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

“Ply” or “Plies”, as used herein, means an individual fibrous structure or sheet of fibrous structure, optionally to be disposed in a substantially contiguous, face-to-face relationship with other plies, forming a multi-ply fibrous structure. It is also contemplated that a single fibrous structure can effectively form two “plies” or multiple “plies”, for example, by being folded on itself. In one embodiment, the ply has an end use as a tissue-towel paper product. A ply may comprise one or more wet-laid layers, air-laid layers, and/or combinations thereof. If more than one layer is used, it is not necessary for each layer to be made from the same fibrous structure. Further, the fibers may or may not be homogenous within a layer. The actual makeup of a tissue paper ply is generally determined by the desired benefits of the final tissue-towel paper product, as would be known to one of skill in the art. The fibrous structure may comprise one or more plies of non-woven materials in addition to the wet-laid and/or air-laid plies.

The term “fibrous structure”, as used herein, means an arrangement of fibers produced in any papermaking machine known in the art to create a ply of paper. “Fiber” means an elongate particulate having an apparent length greatly exceeding its apparent width. More specifically, and as used herein, fiber refers to such fibers suitable for a papermaking process.

“Basis Weight”, as used herein, is the weight per unit area of a sample reported in lbs/3000 ft² or g/m².

“Machine Direction” or “MD”, as used herein, means the direction parallel to the flow of the fibrous structure through the papermaking machine and/or product manufacturing equipment.

“Cross Machine Direction” or “CD”, as used herein, means the direction perpendicular to the machine direction in the same plane of the fibrous structure and/or fibrous structure product comprising the fibrous structure.

### Fibrous Structure Sheets

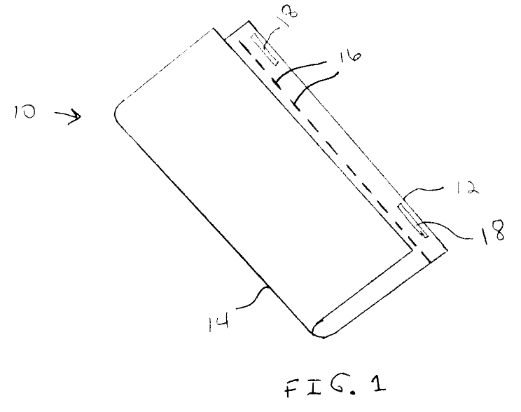

The sheets herein may, in an embodiment, be in a folded configuration such as half-folds or quarter-folds of the sheets. A sheet having a half-fold configuration is shown in FIG. 1. A sheet 10, which is an individual sheet having 4 different edges, has a first end 12 and a second end 14, opposite to the first end 12. Perforation lines 16 are disposed along the first end 12 adjacent to the attachment element 18 to enable the sheets to be removed individually from the tissue product. The attachment element 18 comprises staples and/or a strip of adhesive.

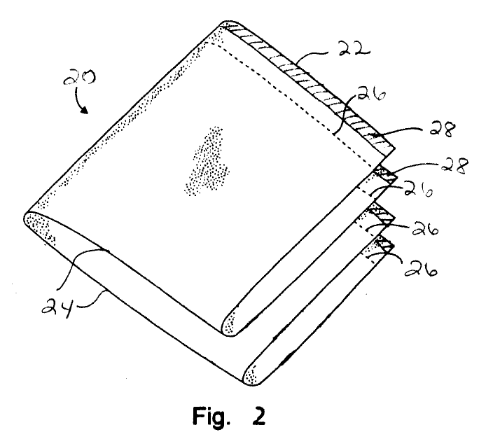

Alternatively, the sheets herein may, in an embodiment, be in a quarter-fold configuration. A sheet having a quarter-fold configuration is shown in FIG. 2. A sheet 20, which is an individual sheet having 4 different edges, has a first end 22 and a second end 24 opposite to the first end 22. Perforation lines 26 are disposed along the first end 22 adjacent to the attachment element 28 to enable the sheet to be removed individually from the tissue product. The attachment element 28 comprises a continuous strip of adhesive. Other folding configurations may also be useful herein, for example, Z-folds, or C-folds.

The attachment element herein may be a mechanical attachment element, a chemical attachment element, and combinations thereof. The attachment element, in an embodiment, is provided so that each sheet is individually releasable from the product. In one embodiment, an attachment element is provided herein that is disposed at least partially along the first end of the sheets. In an embodiment the attachment element may be disposed along the first ends of the sheets, securing the plurality of sheets to each other along the first ends. In another embodiment the attachment element may be disposed along the full length of the first ends of the sheets, in a continuous manner. In the alternative the attachment element may be disposed as discrete elements such as for example as adhesive stripes, adhesive dots, or other patterns, rivets, pins, screws, wire, staples, stitches, tacks, clips, along at least a portion of each sheet so that each sheet is at least partially attached to an adjacent sheet or attached to a header.

In one embodiment, chemical attachment includes any adhesive known in the art such as water soluble glues, water-resin emulsions, solvent-based adhesives, hot-melt adhesives, thermoplastic films (such as polyethylene, polypropylene, polyvinylchloride), dextrin glue, polyvinyl acetate, polyvinyl alcohols, and combinations thereof.

For example, the attachment element may also be a mechanical attachment element such as rivets, pins, screws, wire, staples, stitches, tacks, clips, one or more rods inserted through the thickness of the plurality of sheets, and combinations thereof. In one embodiment the mechanical attachment element further comprises a header.

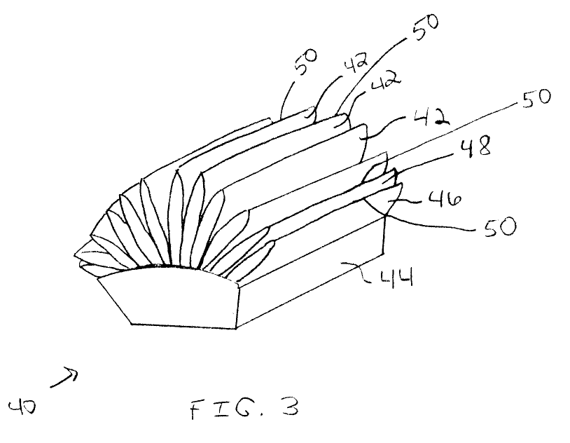

FIG. 3 is a perspective view of tissue product 40 with a plurality of fibrous structure sheets 42. The sheets are in a half fold configuration and are housed in a dispenser 44. The dispenser 44 may be either open or may have an over wrap of polyethylene, polypropylene, cellophane, paper, etc. to protect the tissue product from contamination. The dispenser 44 may also have a plastic, dome shaped cover. The tissue product 40 comprises a plurality of fibrous structure sheets 42 including a first sheet 46 and a second sheet 48, the second sheet 48 being adjacent to the first sheet 46. The first sheet 46 and the second sheet 48 each comprise a first end housed within the dispenser 44, and second ends 50 opposite to the first ends, wherein the first end of the first sheet 46 is proximal to the first end of the second sheet 48, and the second ends 50 of the first sheet and the second sheet are arranged in a splayed orientation.

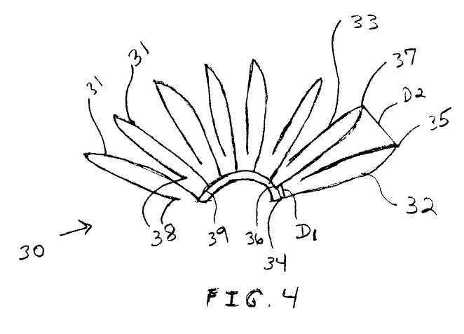

FIG. 4 is a plain view of a tissue product 30 comprising a plurality of fibrous structure sheets 31 in a half fold configuration according to an embodiment of the invention. As shown in FIG. 4, the tissue product 30 has a first sheet 32 and a second sheet 33. The first sheet 32 has a first end 34 and a second end 35 opposite to the first end 34. The second sheet 33 has a first end 36 and a second end 37, opposite to the first end 36. Each sheet 31 has a second edge 38. The first end 34 of the first sheet 32 and the first end 36 of the second sheet 33 are proximal to each other and are attached via an attachment element to a header 39.

The first sheet 32 and the second sheet 33 comprise a first distance D1 between the first end 34 of the first sheet 32 and the first end 36 of the second sheet 33. The first sheet 32 and the second sheet 33 comprise a second distance, D2, between the second end 35 of the first sheet 32 and the second end 37 of the second sheet 33, and wherein D2 is at least about 20% greater than D1.

In another embodiment the D2 is about 25% greater, and/or about 30% greater, and/or about 50% greater than D1. In another embodiment D2 is from about 20% to about 200% greater, and/or from about 25% to about 200% greater, and/or about 30% to about 150%, greater than D1. In one embodiment D1 is TD1 and D2 is TD2. The method of calculating D1, D2, TD1 and TD2 is disclosed in the Method section herein.

In another embodiment the tissue product may comprise a horizontal or vertical orientation relative to the surface that the tissue product is resting on. The tissue products in FIGS. 3 and 4 have a horizontal orientation. In another embodiment sheets may have a vertical orientation, such that the tissue product header or first ends of the sheets may be fastened vertically to an upright standing standard paper towel dispenser such as that disclosed in U.S. D 298,597, issued Nov. 22, 1988, and wherein the second ends of the sheets radiate outwardly.

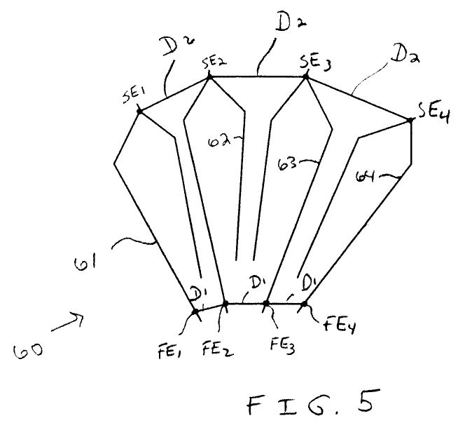

FIG. 5 is a plain view of a tissue product 60 with a first sheet 61, a second sheet 62, a third sheet 63, and a forth sheet 64, all sheets having a half fold configuration. In one embodiment, FE₁ is the first end of the first sheet 61, FE₂ is the first end of the second sheet 62, FE₃ is the first end of the third sheet 63, FE₄ is the first end of the forth sheet 64. SE₁ is the second end of the first sheet 61, SE₂ is the second end of the second sheet 62, SE₃ is the second end of the third sheet 63, and SE₄ is the second end of the forth sheet 64. As shown in FIG. 5, SE₁, SE₂, SE₃, and SE₄ are the furthest relative points, as measured by a straight line, away from the FE₁, of the first sheet 61, FE₂ of the second sheet 62, FE₃ of the third sheet 63, and FE₄ of the forth sheet 64, respectively. D2 is the shortest straight-line distance between SE₁ and SE₂ or between SE₂ and SE₃ or between SE₃ and SE₄. D1 is the shortest straight-line distance between FE₁ and FE₂ or between FE₂ and FE₃ or between FE₃ and FE₄.

In one embodiment the fibrous structure sheets herein have a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In addition, the tissue products may exhibit a total dry tensile strength from about 550 g/in to about 3,000 g/in, and/or from about 800 g/in to about 2,400 g/in, and/or from about 1000 g/in to about 2,000 g/in.

These tensile strengths may enhance dispensing of the sheets by minimize tearing of the sheets upon dispensing and by minimizing premature dislodgement of the sheets from the attachment element, if present.

In one embodiment the sheets are secured in stack configuration only by bonding of the first ends thereof to the first ends of an adjacent sheet, and/or the bonding of the first ends to a header, and therefore, each sheet is individually releasable in substantially its entirety when a pulling force is exerted on it. The amount of the sheet that is left behind after dispensing and removal of the sheet of the tissue product will vary. In one embodiment the only vestige of the sheet remaining on the tissue product after the sheet's removal is a minor amount of fibrous structure which remains bonded to the adjacent sheet and/or header. In another embodiment the sheets will be completely removed with no fibrous structure left behind.

In an embodiment, to remove a sheet from the product shown in FIG. 3 or 4, it is merely necessary to grasp and exert an upward pull or force on the sheet. This force is resisted in one embodiment, by an attachment element. In one embodiment the attachment element may be from one to about four points of adhesive, attaching a sheet to an adjacent sheet at a given instant of time. The full release of the sheets occurs as each point, or group of points, releases. In one embodiment the pulling force required to release one sheet ranges from about 75 grams to about 1000 grams and/or from about 200 to about 500 grams. In one embodiment the dry tensile strength of the sheet is such that the range of the pulling force is at a lower level than the range of the sheet's dry tensile strength described herein so that the separation of the individual sheets occurs at a point immediately adjacent to the attachment element. In one embodiment, if the pulling force necessary to remove an individual sheet is greater than the sheet's dry tensile strength, the sheet may rupture or tear at a point other than at the attachment element. If the pulling force required is below the minimum stated, premature separation of the sheets from the attachment element may occur.

The plurality of sheets herein may be attached to each other, attached to the adjacent sheet, attached to a header, and combinations thereof. For example some of the sheets may be attached to each other wherein less than all of the sheets of the tissue product are attached to a header.

The sheets herein may have a variety of shapes e.g. oval, square, rectangle, round, triangular, etc., and combinations thereof.

### Tissue Product/Fibrous Substrate

In one embodiment the tissue product comprises a fibrous structure. In one embodiment, the fibrous structure has a basis weight of about 15 lbs/3000 ft² to about 50 lbs/3000 ft². In another embodiment the basis weight is about 20 lbs/3000 ft² to about 40 lbs/3000 ft²; in another embodiment the basis weight is about 25 lbs/3000 ft² and about 40 lbs/3000 ft², and in another embodiment the basis weight is about 27 lbs/3000 ft² and about 37 lbs/3000 ft².

The tissue products may incorporate a variety of paper making fibers, such as, natural fibers, synthetic fibers, as well as any other suitable fibers, starches, and combinations thereof. Paper making fibers useful in the present invention include cellulosic fibers commonly known as wood pulp fibers. Applicable wood pulps include chemical pulps, such as Kraft, sulfite and sulfate pulps, as well as mechanical pulps including, groundwood, thermomechanical pulp, chemically modified, and the like. Chemical pulps may be used in tissue towel embodiments since they are known to those of skill in the art to impart a superior tactical sense of softness to tissue sheets made therefrom. Pulps derived from deciduous trees (hardwood) and/or coniferous trees (softwood) can be utilized herein. Such hardwood and softwood fibers can be blended or deposited in layers to provide a stratified web. Exemplary layering embodiments and processes of layering are disclosed in U.S. Pat. Nos. 3,994,771 and 4,300,981. Additionally, fibers derived from wood pulp such as cotton linters, bagesse, and the like, can be used. Additionally, fibers derived from recycled paper, which may contain any of all of the categories as well as other non-fibrous materials such as fillers and adhesives used to manufacture the original paper product may be used in the present web. In addition, fibers and/or filaments made from polymers, specifically hydroxyl polymers, may be used in the present invention. Non-limiting examples of suitable hydroxyl polymers include polyvinyl alcohol, starch, starch derivatives, chitosan, chitosan derivatives, cellulose derivatives, gums, arabinans, galactans, and combinations thereof. Additionally, other synthetic fibers such as rayon, polyethylene, and polypropylene fibers can be used within the scope of the present invention. Further, such fibers may be latex bonded.

In one embodiment the paper is produced by forming predominantly aqueous slurry comprising about 95% to about 99.9% water. The aqueous slurry can be pumped to the headbox of the papermaking process.

In one embodiment the present invention may comprise a co-formed fibrous structure. A co-formed fibrous structure comprises a mixture of at least two different materials wherein at least one of the materials comprises a non-naturally occurring fiber, such as a polypropylene fiber, and at least one other material, different from the first material, comprising a solid additive, such as another fiber and/or a particulate. In one example, a co-formed fibrous structure comprises solid additives, such as naturally occurring fibers, such as wood pulp fibers, and non-naturally occurring fibers, such as polypropylene fibers.

Synthetic fibers useful herein include any material, such as, but not limited to polymers, such as those selected from the group consisting of polyesters, polypropylenes, polyethylenes, polyethers, polyamides, polyhydroxyalkanoates, polysaccharides, and combinations thereof. More specifically, the material of the polymer segment may be selected from the group consisting of poly(ethylene terephthalate), poly(butylene terephthalate), poly(1,4-cyclohexylenedimethylene terephthalate), isophthalic acid copolymers (e.g., terephthalate cyclohexylene-dimethylene isophthalate copolymer), ethylene glycol copolymers (e.g., ethylene terephthalate cyclohexylene-dimethylene copolymer), polycaprolactone, poly(hydroxyl ether ester), poly(hydroxyl ether amide), polyesteramide, poly(lactic acid), polyhydroxybutyrate, and combinations thereof.

Further, the synthetic fibers can be a single component (i.e., single synthetic material or a mixture to make up the entire fiber), bi-component (i.e., the fiber is divided into regions, the regions including two or more different synthetic materials or mixtures thereof and may include co-extruded fibers) and combinations thereof. It is also possible to use bicomponent fibers, or simply bicomponent or sheath polymers. Nonlimiting examples of suitable bicomponent fibers are fibers made of copolymers of polyester (polyethylene terephthalate)/polyester (polyethylene terephthalate) otherwise known as “CoPET/PET” fibers, which are commercially available from Fiber Innovation Technology, Inc., Johnson City, Tenn.

These bicomponent fibers can be used as a component fiber of the structure, and/or they may be present to act as a binder for the other fibers present. Any or all of the synthetic fibers may be treated before, during, or after the process of the present invention to change any desired properties of the fibers. For example, in certain embodiments, it may be desirable to treat the synthetic fibers before or during the papermaking process to make them more hydrophilic, more wettable, etc.

These multicomponent and/or synthetic fibers are further described in U.S. Pat. Nos. 6,746,766, issued on Jun. 8, 2004; 6,946,506, issued Sep. 20, 2005; 6,890,872, issued May 10, 2005; US Publication No. 2003/0077444A1, published on Apr. 24, 2003; US Publication No. 2003/0168912A1, published on Nov. 14, 2002; US Publication No. 2003/0092343A1, published on May 15, 2003; US Publication No. 2002/0168518A1, published on Nov. 14, 2002; US Publication No. 2005/0079785A1, published on Apr. 14, 2005; US Publication No. 2005/0026529A1, published on Feb. 3, 2005; US Publication No. 2004/0154768A1, published on Aug. 12, 2004; US Publication No. 2004/0154767, published on Aug. 12, 2004; US Publication No. 2004/0154769A1, published on Aug. 12, 2004; US Publication No. 2004/0157524A1, published on Aug. 12, 2004; US Publication No. 2005/0201965A1, published on Sep. 15, 2005.

The fibrous structure may comprise any tissue-towel paper product known in the industry. Embodiment of these structures may be made according U.S. Pat. Nos. 4,191,609 issued Mar. 4, 1980 to Trokhan; 4,300,981 issued to Carstens on Nov. 17, 1981; 4,191,609 issued to Trokhan on Mar. 4, 1980; 4,514,345 issued to Johnson et al. on Apr. 30, 1985; 4,528,239 issued to Trokhan on Jul. 9, 1985; 4,529,480 issued to Trokhan on Jul. 16, 1985; 4,637,859 issued to Trokhan on Jan. 20, 1987; 5,245,025 issued to Trokhan et al. on Sep. 14, 1993; 5,275,700 issued to Trokhan on Jan. 4, 1994; 5,328,565 issued to Rasch et al. on Jul. 12, 1994; 5,334,289 issued to Trokhan et al. on Aug. 2, 1994; 5,364,504 issued to Smurkowski et al. on Nov. 15, 1995; 5,527,428 issued to Trokhan et al. on Jun. 18, 1996; 5,556,509 issued to Trokhan et al. on Sep. 17, 1996; 5,628,876 issued to Ayers et al. on May 13, 1997; 5,629,052 issued to Trokhan et al. on May 13, 1997; 5,637,194 issued to Ampulski et al. on Jun. 10, 1997; 5,411,636 issued to Hermans et al. on May 2, 1995; EP 677612 published in the name of Wendt et al. on Oct. 18, 1995, and U.S. Patent Application 2004/0192136A1 published in the name of Gusky et al. on Sep. 30, 2004.

The tissue-towel substrates may be manufactured via a wet-laid making process where the resulting web is through-air-dried or conventionally dried. Optionally, the substrate may be foreshortened by creping or by wet microcontraction. Creping and/or wet microcontraction are disclosed in commonly assigned U.S. Pat. Nos. 6,048,938 issued to Neal et al. on Apr. 11, 2000; 5,942,085 issued to Neal et al. on Aug. 24, 1999; 5,865,950 issued to Vinson et al. on Feb. 2, 1999; 4,440,597 issued to Wells et al. on Apr. 3, 1984; 4,191,756 issued to Sawdai on May 4, 1980; and 6,187,138 issued to Neal et al. on Feb. 13, 2001.

Conventionally pressed tissue paper and methods for making such paper are known in the art, for example U.S. Pat. No. 6,547,928 issued to Barnholtz et al. on Apr. 15, 2003. Processes for making pattern densified tissue webs are disclosed in U.S. Pat. No. 3,301,746, issued to Sanford, et al. on Jan. 31, 1967; U.S. Pat. No. 3,974,025, issued to Ayers on Aug. 10, 1976; U.S. Pat. No. 4,191,609, issued to on Mar. 4, 1980; and U.S. Pat. No. 4,637,859, issued to on Jan. 20, 1987; U.S. Pat. No. 3,301,746, issued to Sanford, et al. on Jan. 31, 1967; U.S. Pat. No. 3,821,068, issued to Salvucci, Jr. et al. on May 21, 1974; U.S. Pat. No. 3,974,025, issued to Ayers on Aug. 10, 1976; U.S. Pat. No. 3,573,164, issued to Friedberg, et al. on Mar. 30, 1971; U.S. Pat. No. 3,473,576, issued to Amneus on Oct. 21, 1969; U.S. Pat. No. 4,239,065, issued to Trokhan on Dec. 16, 1980; and U.S. Pat. No. 4,528,239, issued to Trokhan on Jul. 9, 1985.

Uncompacted, non pattern-densified tissue paper structures are also contemplated within the scope of the present invention and are described in U.S. Pat. No. 3,812,000 issued to Joseph L. Salvucci, Jr. et al. on May 21, 1974; and U.S. Pat. No. 4,208,459, issued to Henry E. Becker, et al. on Jun. 17, 1980. Uncreped tissue paper as defined in the art are also contemplated. The techniques to produce uncreped tissue in this manner are taught in the prior art. For example, Wendt, et al. in European Patent Application 0 677 612A2, published Oct. 18, 1995; Hyland, et al. in European Patent Application 0 617 164 A1, published Sep. 28, 1994; and Farrington, et al. in U.S. Pat. No. 5,656,132 issued Aug. 12, 1997.

Uncreped tissue paper, in one embodiment, refers to tissue paper which is non-compressively dried, by through air drying. Resultant through air dried webs are pattern densified such that zones of relatively high density are dispersed within a high bulk field, including pattern densified tissue wherein zones of relatively high density are continuous and the high bulk field is discrete. The techniques to produce uncreped tissue in this manner are taught in the prior art. For example, Wendt, et. al. in European Patent Application 0 677 612A2, published Oct. 18, 1995; Hyland, et. al. in European Patent Application 0 617 164 A1, published Sep. 28, 1994; and Farrington, et. al. in U.S. Pat. No. 5,656,132 published Aug. 12, 1997.

In one embodiment, the fibrous substrate is a through air dried paper made according to the foregoing patents and has a plurality of domes formed during the papermaking process which are dispersed throughout an essentially continuous network region. The domes extend generally perpendicular to the paper and increase its caliper. The domes generally correspond in geometry, and during papermaking in position, to the deflection conduits of the belt described above. There are an infinite variety of possible geometries, shapes, and arrangements for the deflection conduits and the domes formed in the paper therefrom. These shapes include those disclosed in commonly assigned U.S. Pat. No. 5,275,700 issued on Jan. 4, 1994 to Trokan. Examples of these shapes include, but are not limited to those described as a bow-tie pattern or snowflake pattern. Further examples of these shapes include, but are not limited to, circles, ovals, diamonds, triangles, hexagons, and various quadrilaterals.

The domes that form the essentially continuous network of domes protrude outwardly from the plane of the paper due to molding into the deflection conduits during the papermaking process. By molding into the deflection conduits during the papermaking process, the regions of the paper comprising the domes are deflected in the Z-direction.

If the fibrous structure has domes, or other prominent features in the topography, the domes, or other prominent feature, may be arranged in a variety of different configurations. These configurations include, but are not limited to: regular arrangements, random arrangements, multiple regular arrangements, and combinations thereof.

The fibrous structure product according to the present invention having domes may be made according to commonly assigned U.S. Pat. No. 4,528,239 issued Jul. 9, 1985 to Trokhan; U.S. Pat. No. 4,529,480 issued Jul. 16, 1985 to Trokhan; U.S. Pat. No. 5,275,700 issued Jan. 4, 1994 to Trokhan; U.S. Pat. No. 5,364,504 issued Nov. 15, 1985 to Smurkoski et al.; U.S. Pat. No. 5,527,428 issued Jun. 18, 1996 to Trokhan et al.; U.S. Pat. No. 5,609,725 issued Mar. 11, 1997 to Van Phan; U.S. Pat. No. 5,679,222 issued Oct. 21, 1997 to Rasch et al.; U.S. Pat. No. 5,709,775 issued Jan. 20, 1995 to Trokhan et al.; U.S. Pat. No. 5,795,440 issued Aug. 18, 1998 to Ampulski et al.; U.S. Pat. No. 5,900,122 issued May 4, 1999 to Huston; U.S. Pat. No. 5,906,710 issued May 25, 1999 to Trokhan; U.S. Pat. No. 5,935,381 issued Aug. 10, 1999 to Trokhan et al.; and U.S. Pat. No. 5,938,893 issued Aug. 17, 1999 to Trokhan et al.

In one embodiment the fibrous structure is made using the papermaking belt as disclosed in U.S. Pat. No. 5,334,289, issued on Aug. 2, 1994, Paul Trokhan and Glenn Boutilier.

Suitable means of laminating the plies include but are not limited to those methods disclosed in commonly assigned U.S. Pat. Nos. 6,113,723 issued to McNeil et al. on Sep. 5, 2000; 6,086,715 issued to McNeil on Jul. 11, 2000; 5,972,466 issued to Trokhan on Oct. 26, 1999; 5,858,554 issued to Neal et al. on Jan. 12, 1999; 5,693,406 issued to Wegele et al. on Dec. 2, 1997; 5,468,323 issued to McNeil on Nov. 21, 1995; 5,294,475 issued to McNeil on Mar. 15, 1994.

In one example, tissue products comprise a plurality of single- and/or multi-ply sanitary tissue products. The sanitary tissue products may be dry and/or wet. The packages may be displayed on a shelf at a point of sale, such as within a retail store, in such as way that the different sanitary tissue products or packages are visible to a consumer during the consumer's purchasing decision process. The package may comprise a mixture of single-ply and multi-ply sanitary tissue products.

### EXAMPLE I

A web of fibrous substrate may be manufactured via a wet-laid making process where the resulting web is through-air-dried or conventionally dried or may be made via a conventionally pressed tissue paper method, for example see U.S. Pat. No. 6,547,928 issued to Barnholtz et al. on Apr. 15, 2003, U.S. Pat. No. 3,301,746, issued to Sanford, et al. on Jan. 31, 1967; U.S. Pat.

No. 4,528,239 issued Jul. 9, 1985 to Trokhan; U.S. Pat. No. 4,529,480 issued Jul. 16, 1985 to Trokhan; U.S. Pat. No. 5,275,700 issued Jan. 4, 1994 to Trokhan; U.S. Pat. No. 5,364,504 issued Nov. 15, 1985 to Smurkoski et al.; U.S. Pat. No. 5,527,428 issued Jun. 18, 1996 to Trokhan et al.; U.S. Pat. No. 5,609,725 issued Mar. 11, 1997 to Van Phan; U.S. Pat. No. 5,679,222 issued Oct. 21, 1997 to Rasch et al.

Thereafter, if desired, print or emboss the web of fibrous substrate. Thereafter, the web is sent through a unit operation that cuts the web into usable individual sheet units. The individual sheets are then folded in half along the midpoint of the sheet. Thereafter, the folded sheets are aligned and stacked on top of each other with folded edges aligned.

The number of sheets in the stack corresponds to the number of usable units desired in the finished tissue product. The stacked sheets are nipped together in relative position to one another by vertical force clamps positioned on opposing sides of the stack. The inner bottom of a dispenser housing is coated with a hot melt adhesive. The clamped stack of sheets is inserted into the dispenser housing so that the first ends of the sheets are contacted with the adhesive. The adhesive is allowed to cure, solidify, or dry. Thereafter, the sheets may be removed directly from the adhesive strip and a perforation is optional. The clamps are then removed from the stack.

In another embodiment the stacked sheets are nipped together in relative position to one another by vertical force clamps positioned on opposing sides of the stack. Once secured in the clamps, slide the first ends over a adhesive roller to apply adhesive to the first ends. The adhesive may be allowed to cure, solidify or dry, and the tissue product may be used as is without a dispenser.

### EXAMPLE II

A web of fibrous substrate may be manufactured as in Example I. Thereafter the web is embossed. The web is then payed off of a roller in the MD. The web is then fed into a folding device, which folds the web into a “Z” fold so that the edges of the web are aligned with one another. The web is folded so that each folded portion creates a plurality of sheets of the same dimensions. The stack of “Z” folded sheets is not further cut. The stacked sheets are nipped together in relative position to one another by vertical force clamps positioned on opposing sides of the stack. The inner bottom of a dispenser housing is coated with a hot melt adhesive. The clamped stack of sheets is inserted into the dispenser housing so that the first ends of the sheets are contacted with the adhesive. The adhesive is allowed to cure, solidify, or dry. In this form the sheets may be removed directly from the adhesive strip and a perforation may not be necessary. The clamps are removed from the stack.

In another embodiment the stacked sheets are nipped together in relative position to one another by vertical force clamps positioned on opposing sides of the stack. Once secured in the clamps, slide the first ends over an adhesive roller to apply adhesive to the first ends. The adhesive is allowed to cure, solidify or dry, and the tissue product may be used as is without a dispenser.

### Test Methods

The following describes the test methods utilized herein to determine the values consistent with those presented herein. All measurements for the test methods are made at 23+/−1° C. and 50%+/−2% relative humidity, unless otherwise specified.

### Tensile Strength Test Method:

One (1) inch by five (5) inch (2.5 cm×12.7 cm) strips of fibrous structure and/or sanitary tissue product are provided. The strip is placed on an electronic tensile tester Model 1122 commercially available from Instron Corp., Canton, Mass. in a conditioned room at a temperature of 73° F.±4° F. (about 28° C.±2.2° C.) and a relative humidity of 50%±10%. The crosshead speed of the tensile tester is 2.0 inches per minute (about 5.1 cm/minute) and the gauge length is 4.0 inches (about 10.2 cm). The Dry Tensile Strength can be measured in any direction by this method. The “Total Dry Tensile Strength” or “TDT” is determined by the arithmetic total of MD and CD tensile strengths of the strips.

### D1 and D2 Measurement Method

Place the tissue product such that the first ends or the header (if present) are resting on a flat horizontal surface. Allow the tissue product to physically equilibrate for about 5 minutes, so that it is no longer moving. As shown in FIG. 5, FE₁ is the first end of the first sheet 61, FE₂ is the first end of the second sheet 62, FE₃ is the first end of the third sheet 63, FE₄ is the first end of the forth sheet 64. SE₁ is the second end of the first sheet 61, SE₂ is the second end of the second sheet 62, SE₃ is the second end of the third sheet 63, and SE₄ is the second end of the forth sheet 64. As shown in FIG. 5, SE₁, SE₂, SE₃, and SE₄ are the furthest relative points, as measured by a straight line, away from the FE₁ of the first sheet 61, FE₂ of the second sheet 62, FE₃ of the third sheet 63, and FE₄ of the forth sheet 64, respectively. D2 is the shortest straight-line distance between SE₁ and SE₂ or between SE₂ and SE₃ or between SE₃ and SE₄. D1 is the shortest straight-line distance between FE₁ and FE₂ or between FE₂ and FE₃ or between FE₃ and FE₄. If two or more second ends (points) are equal in distance from a first end, then the point that is closest to the adjacent sheet is designated as the second end.

To calculate the total D1 (TD1) for all sheets of the tissue product, add the total of all of the D1 values.

To calculate the total D2 (TD2) for all sheets of the tissue product, add the total of all of the D2 values.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A tissue product comprising:
a plurality of absorbent, fibrous structure sheets comprising at least a first sheet and a second sheet that is adjacent to the first sheet, the first sheet and the second sheet each comprising a first end and a second end opposite to the first end, wherein the first end of the first sheet is proximal to the first end of the second sheet, and the second end of the first sheet and the second end of the second sheet are arranged in a splayed orientation.

2. The product of claim 1 wherein the sheets are in a folded configuration.

3. The product of claim 2 wherein the folded configuration comprises half-folds or quarter-folds.

4. The product of claim 1 further comprising an attachment element disposed at least partially along the first ends of the sheets.

5. The product of claim 4 wherein the attachment element comprises a mechanical attachment element, a chemical attachment element, and combinations thereof.

6. The product of claim 5 wherein the attachment element is selected from the group consisting of rivets, pins, screws, wire, staples, stitches, tacks, clips, rods, water soluble glues, water-resin emulsions, solvent-based adhesives, hot-melt adhesives, thermoplastic films, polyethylene, polypropylene, polyvinylchloride, and combinations thereof.

7. The product of claim 1 further comprising weakened lines along the first ends to enable the sheets to be separated and removed.

8. The product of claim 7 wherein the weakened lines comprise perforated lines.

9. The product of claim 1 wherein the sheets comprise 1 ply or multiple plies.

10. The product of claim 1 wherein the sheets are in a stacked configuration.

11. The product of claim 1 wherein the tissue product comprises a vertical or horizontal orientation.

12. The product of claim 4 wherein the attachment element joins the first sheet to the second sheet.

13. The product of claim 4 further comprising a header wherein the attachment element joins the first ends of the sheets to the header.

14. A tissue product comprising:
a plurality of absorbent, fibrous structure sheets comprising at least a first sheet and a second sheet that is adjacent to the first sheet, the first sheet and the second sheet each comprising a first end and a second end opposite to the first end, wherein the first end of the first sheet is proximal to the first end of the second sheet, and an attachment element disposed on the first ends, wherein the first sheet and the second sheet comprise a first distance D1 between the first ends and a second distance, D2, between the second ends, and wherein D2 is at least about 20% greater than D1.

15. The tissue product of claim 14 wherein D2 is about 30% greater than D1.

16. The tissue product of claim 15 wherein D2 is about 20% to about 200% greater than D1.

17. The tissue product of claim 16 wherein D2 is about 25% to about 150%, greater than D1.

18. The tissue product of claim 14 wherein D1 is TD1 and D2 is TD2.

19. A tissue product comprising:
a plurality of absorbent, fibrous structure sheets comprising at least a first sheet and a second sheet that is adjacent to the first sheet, the first sheet and the second sheet each comprising a first end and a second end opposite to the first end, wherein the first end of the first sheet is proximal to the first end of the second sheet, and
a refill package for a dispenser that arranges the second end of the first sheet and the second end of the second sheet in a splayed orientation.
